(19) United States
(12) Patent Application Publication
(10) Pub. No.: US 2002/0180955 A1
(43) Pub. Date: Dec. 5, 2002

(54) Method and system for measuring multi-segment LED modules

(75) Inventors: Chun-Yu Lin, Tainan (TW); Yaomin Lin, Hsinchu (TW)

Correspondence Address: Ladas & Parry, 260 West 61st Street, New York, NY, 10023, US

(73) Assignee: INDUSTRIAL TECHNOLOGY RESEARCH INSTITUTE

(21) Appl. No.: 10/004,629

(22) Filed: Dec. 4, 2001

(30) Foreign Application Priority Data
May 3, 2001 (TW) 90110605

(51) Int. Cl. G01J 1/00

(52) U.S. Cl. 356/121

(57) ABSTRACT

The present invention relates to a novel methods and system for measuring multi-segment LED module. The present method utilizes a camera to photograph an image of the multi-segment LED modules, and proceeds an image vector location algorithm in a computer to ensure the bright part of the photographed image could be captured stably and to overcome rotating and shifting problems of the conventional multi-segment LED modules. By the image-processing steps of the present invention, the problems of low throughput and errors occurred in the prior art could be efficiently resolved.

### BACKGROUND OF THE INVENTION

1. Field of the Invention

The present invention relates to a method and system for measuring multi-segment LED modules, and particularly to a method and system for measuring multi-segment LED modules by utilizing image-processing technology.

2. Description of Related Art

Usually, many measuring procedures for multi-segment LED modules are conducted before shipment to eliminate defective products. Conventionally, the detection of multi-segment LED modules focuses on measurements of lighting points such as coloring, brightness and uniformity, but other aspects such as measurements of light leakage have always been omitted. A number of factories even conduct the detection of light leakage, but they only use a mask to separate the segments they want and then use a photo detector to measure the total brightness and to defect if a light leakage occurs. The disadvantage of the conventional method is that a great amount of time is spent due to switching between mechanical masks, therefore the throughput is limited and the measuring cost is very high. Besides, since the mechanical measurements are conducted at different time slots and different segments, errors are inevitable due to different comparison bases.

### SUMMARY OF THE INVENTION

For resolving the above problems, the present invention provides a novel method and system for measuring multi-segment LED modules. The present method utilizes a camera to photograph images of the multi-segment LED modules, and performs an image vector location algorithm in a computer to ensure that the bright part of the photographed image can be captured stably and to overcome rotating and shifting problems of the conventional multi-segment LED modules. By the image-processing steps of the present invention, the problems of the low throughput and errors encountered in the prior art can be efficiently resolved.

To obtaining a full-aspect measurement, breaking through the bottleneck of a speed measurement and avoiding errors caused by measurements at different time slots, the present invention utilizes a 2-dimentional array camera (such as a CCD camera) to act as a photo detector. The measuring results are then into digital signals, which are saved as quantized image signals. The measuring method of the present invention calculates hues, brightness, uniformity and light leakage in every segment of multi-segment LED modules.

The image vector location algorithm of the present invention includes the following steps: (1) image segmentation; (2) segment clustering; and (3) segment location. In the step of image segmentation, the bright clustering in the image are first searched, and then the searched results are stored in linking lists. In the step of segment grouping, the segments belonging to the same multi-segment LED module after partition are clustered. In the step of segment locating, every bright segment of the multi-segment LED module is located.

### BRIEF DESCRIPTION OF THE DRAWINGS

The present invention will be described according to the appended drawings in which:

FIG. 1 is a measuring system of the present invention;

FIGS. 2(a) and (b) show the multi-segment LED module and the corresponding linear regression curve according to the present invention; and

FIGS. 3(a) and (b) show a serial number of every segment and its corresponding coordinate.

### PREFERRED EMBODIMENT OF THE PRESENT INVENTION

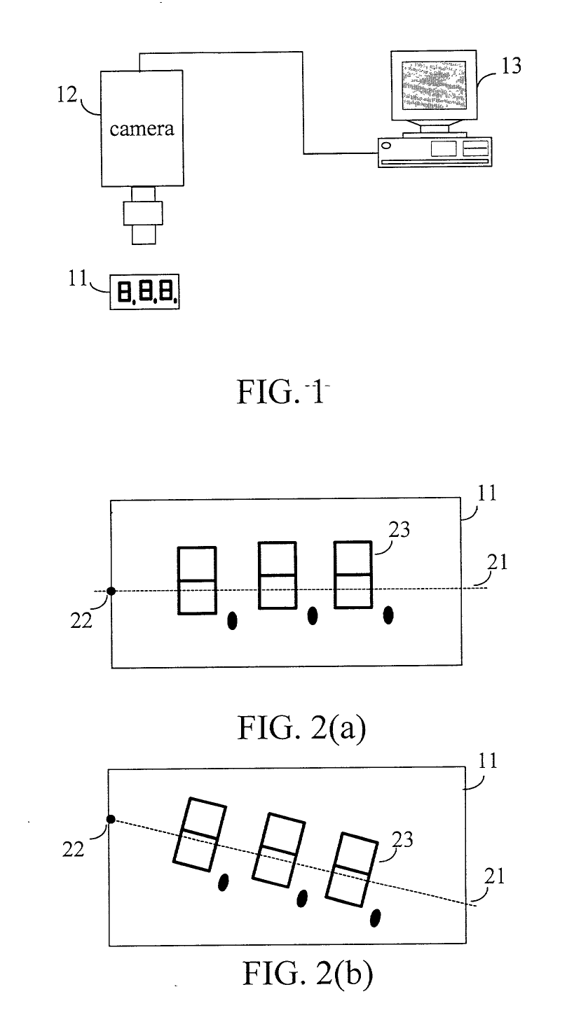

FIG. 1 is a measuring system of the present invention. The system comprises a plurality of multi-segment LED modules 11, a camera 12 and a computer 13. The difference between the present invention and the prior art is that the present invention first photographs images of the multi-segment LED modules 11 with the camera 12, and then transfers the images into the computer 13 for image processing. By image-processing technology, the present invention can locate the lighting segments of the multi-segment LED modules 11.

The present invention utilizes an image vector location algorithm to ensure that the lighting segment of the captured image can be stably extracted, and to overcome the rotating and shifting problems of the multi-segment LED modules 11. The image vector location algorithm could be performed into three steps: (1) image segmentation; (2) segment clustering; and (3) segment location.

In the step of image division, a threshold of the image intensity is first set. The way to set the threshold is to first search a pixel having the highest intensity among all pixels of the image, and then multiply the highest intensity by a coefficient λ to form the threshold, wherein λ is a real number between zero and one (0<λ<1).

Subsequently, second step all pixels of the image are searched. The pixels whose intensity are larger than the threshold are retained and the pixels belonging to the same segment are linked together. To ensure the pixels in a linking list belong to the same segment, the image division described thereinafter is achieved by a region growing algorithm.

The regional growth is achieved by combining neighboring pixels or sub-regions with the same property (such as gray level, texture, color) into a larger one. The result of the region growing will be put into linking lists, and the number of linking lists created by the regional growth is proportional or equal to the number of segments of the multi-segment LED modules 11.

In the step of segment clustering, the linking lists created by the above image segementation method are sorted from a first seed point of the first segment, therefore which segments are clustered in an individual multi-segment LED 23 cannot be determined, such that following measuring data (such as light leakage) cannot be calculated. In other words, not only the segments with the same property of the multi-segment LED 23 should be found by image segmentation, but the segments also should be grouped and located.

The method for segment clustering is achieved as follows:

(1) Generating the central point \vec{I}ᵢ of every segment, wherein 0≦i<N, N represents the number of segments of the multi-segment LED modules 11, \vec{I}ᵢ represents the non-clustering or non-locating central point of the i-th segment.

(2) The sampling points are picked up from the central point of every segment, and a liner regression line 21 is generated according to these sampling points. The method to generate the linear regression line 21 is as follows:

(a) Assuming the equation of the linear regression line 21 is mx+y+n=0

(b) Letting φ=mx+y+n

(c) Defining an energy function as

$$f = {\sum }_{i} {φ}_{i}^{2} = {\sum }_{i} {( {mx}_{i} + {y}_{i} + n )}^{2} ,$$

wherein \vec{I}ᵢ=(xᵢ,yᵢ)

(d) Resolving the following equations to find suitable m and n to minimize the energy functions ƒ.

$$\{ \begin{matrix}\frac{\partial f}{\partial m} = 0 \\ \frac{\partial f}{\partial n} = 0\end{matrix}$$

(3) Assuming the reference point 22 intersected between the liner regression line 21 and the boundary of the image has a coordinate \vec{R}=(0,−n).

(4) Sorting the distances dᵢ²=∥\vec{I}ᵢ−\vec{R}∥² from the central point of every segment to the reference point 22, and clustering every eight segments with a minimal distance until all segments are grouped. A coefficient \vec{E}ₖₕ represents the central point of the h-th non-locating segment of the k-th multi-segment LED 23.

Please refer to FIGS. 2(a) and (b), the multi-segment LED modules 11 have three multi-segment LEDs 23. Regardless of whether the placement of the multi-segment LED modules 11 is parallel to the camera 12, a linear regression line 21 and reference points 22 can be found.

In the steps of locating segments, it can be described as the following steps:

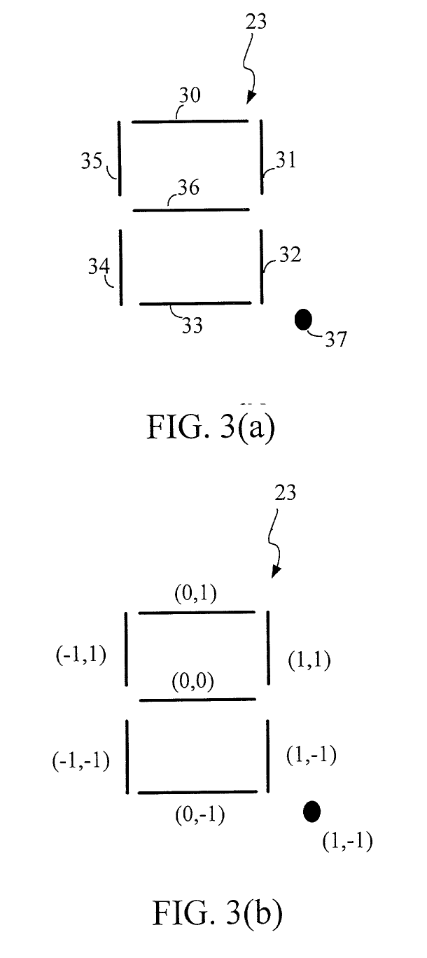

(1) Defining the serial number of every segment of the multi-segment LED 23 and the corresponding position of the central point of every segment. FIG. 3(a) shows one embodiment of the serial number of every segment. FIG. 3(b) shows the coordinate of every segment corresponding to the barycenter of the multi-segment LED 23, and a permutation P grouping the coordinates of the segments 30 to 37 as follows:

$$\vec{P} = [ \begin{matrix}0 & 1 & 1 & 0 & - 1 & - 1 & 0 & 1 \\ 1 & 1 & - 1 & - 1 & - 1 & 1 & 0 & - 1\end{matrix} ] .$$

(2) Adding and averaging the central points of the segments of the k-th multi-segment LED 23 to obtain a barycenter position

$${\vec{C}}_{k} = {\sum }_{h = 0}^{7} {\vec{I}}_{kh} / 8.$$

(3) Searching a segment 36 whose central point \vec{E}ₖₕ is the closest one to the barycenter \vec{C}ₖ of the multi-segment LED 23 among all segments. The central point is \vec{S}ₖ₆, and

$${\vec{S}}_{k6} = arg {min}_{{d}_{kh}} {\vec{E}}_{kh} , {d}_{kh}^{2} = {‖ {\vec{E}}_{kh} - {\vec{C}}_{k} ‖}^{2} .$$

(4) Searching and sorting the segments 32 and 37 of the multi-segment LED 23. Let g(a,b)=(\vec{E}ₖₐ−\vec{S}ₖ₆)·(\vec{E}_{kb}−\vec{S}ₖ₆), a≠b, and resolving suitable a, b to maximize g(a,b). When dₖₐ>d_{kb}, then the equations of \vec{S}ₖ₇=\vec{E}ₖₐ and \vec{S}ₖ₂=\vec{E}_{kb} are sustained. In other words, the dot product of the corresponding vectors of the segments 37 and 32 is the maximum among all dot products of the multi-segment LED 23.

(5) Calculating the bias angle θ of the multi-segment LED modules 11 in the captured image, wherein θ=∠(\vec{S}ₖ₇−\vec{S}ₖ₆)−∠\vec{P}₇.

(6) Rotating the pattern of the multi-segment LED modules 11 by the bias angle θ; \vec{P}ₕ=R\vec{P}ₕ, wherein

$$R = [ \begin{matrix}cos θ & sin θ \\ - cos θ & sin θ\end{matrix} ] .$$

(7) Preceding a dot product of the coordinate of every segment with the vector (1, 1) and selecting the segment having the maximal result to obtain the segment 31. By the same rule, the locations of the segments 33, 34, 35 and 30 could be obtained.

When all segments of the multi-segment LED 23 are located, the parameters such as hues, brightness, uniformity and light leakage of the multi-segment LED 23 can be first calculated according to the image captured by the camera 12 for eliminating defective products and reducing testing capital.

The above-described embodiments of the present invention are intended to be illustrative only. Numerous alternative embodiments may be devised by persons skilled in the art without departing from the scope of the following claims.

What is claimed is:

1. A method for measuring multi-segment LED modules, comprising the following steps:
photographing images of the multi-segment LED modules;
locating lighting segments of the photographed images of the multi-segment LED modules by an image vector location algorithm; and
analyzing whether the photographed multi-segment LED modules are defective.

2. The method of claim 1, wherein the image vector location algorithm comprises the following steps:
segmenting the photographed images and linking pixels belonging to an individual segment;
clustering segments belonging to an individual multi-segment LED; and
locating every segment and obtaining its corresponding coordinate.

3. The method of claim 2, wherein the photographed images are segmented by a region growing algorithm.

4. The method of claim 2, wherein the step of clustering segments comprises the following steps:
generating a linear regression curve depending on a central point of every segment;
generating a cross point of the linear regression curve and an image boundary of the multi-segment LED modules; and
sorting distances from the central points of all segments to the cross point, and clustering the segments according to the sorting sequences.

5. The method of claim 2, wherein the step of locating segments further comprises the following steps:
defining a serial number and a central point of every segment of the multi-segment LED modules;
calculating barycenters of multi-segment LEDs according to the central point of every segment after clustering;
finding out a central segment whose central point is the closest to the barycenter of an individual LED;
finding out right lower and decimal point segments having a maximal dot product after clustering;
calculating a bias angle of the multi-segment LED modules;
adjusting the coordinate of every segment of the multi-segment LED modules according to the bias angle; and
locating residual segments of the multi-segment LED modules according to the maximal dot product.

6. A system for measuring multi-segment LED modules, comprising:
a plurality of multi-segment LED modules;
a camera for photographing images of the multi-segment LED modules; and
a computer connected to the camera, the computer locating the position of every segment of the multi-segment LED modules according to an image vector location algorithm and eliminating defective products according to measuring items.

7. The system of claim 6, wherein the image vector location algorithm further comprises the following steps:
segmenting the photographed image and linking pixels belonging to an individual segment;
clustering segments belonging to an individual multi-segment LED; and
locating every segment and obtaining its corresponding coordinate.
